(19) United States
(12) Patent Application Publication
(10) Pub. No.: US 2004/0133496 A1
(43) Pub. Date: Jul. 8, 2004

(54) Process to detrmine the health of stock market indexes & selecting individual stocks for purchase & sale

(76) Inventor: Gary Hedquist, Norcross, GA (US)

Correspondence Address: GARY HEDQUIST, PO BOX 922665, NORCROSS, GA, 30010, US

(21) Appl. No.: 10/273,645

(22) Filed: Jan. 6, 2003

(51) Int. Cl. G06F 17/60

(52) U.S. Cl. 705/36

(57) ABSTRACT

This document provides an overview of the process to determine the Health of Stock Market Indexes & Individual Stocks.

For each Stock in an Index, compare each day's closing price to that of its Short & Long Term Moving Averages. Classify the Stock as being in one of four possible Phases (Basing, Advancing, Hovering, or Declining).

Calculate the percentage of Stocks in each Phase.

Calculate the Positive & Negative Indicators.

Calculate the difference between the Positive & Negative Indicators. The Health rating is defined below:

| % Difference | Basing | Advancing | Hovering | Declining |
|---|---|---|---|---|
| >0 to +100% | Bullish | BULLISH | Bullish | Unclear |
| 0 to −100% | Bearish | Unclear | Bearish | BEARISH |

Given the Health of the Market Indexes, it is then possible to understand the major market trends and select an investment strategy which is aided by the overall market direction.

This document provides an overview of the process to determine the health of stock market indexes & individual stocks. The process can broken into 5 major steps as follows:

Step 1. For each stock in an index, compare each days closing price to that of its Short & Long Term Moving Averages. The following Table defines this relationship for 4 phases.

| Current Phase | Stock's Daily Closing Price is: |
|---|---|
| Basing | Above ST-MA & Below LT-MA |
| Advancing | Above ST-MA & Above LT-MA |
| Hovering | Below ST-MA & Above LT-MA |
| Declining | Below ST-MA & Below LT-MA |

Step 2. Calculate the percentage of stocks for each day in each of the 4 phases. The sum of the 4 phases for each day should normally be 100%.

Step 3. Calculate the positive & negative indicators each day as defined in the following table.

| Indicator | Phase Percentages |
|---|---|
| Positive | Basing + Advancing |
| Negative | Hovering + Declining |

Step 4. Subtract the current negative indicator from the positive indicator. The difference will be a number from −100% to +100%. Use this value and the current phase rating of the index or stock to determine its health from the table below.

| % Difference | Basing | Advancing | Hovering | Declining |
|---|---|---|---|---|
| >0 to +100% | Bullish | BULLISH | Bullish | Unclear |
| 0 to −100% | Bearish | Unclear | Bearish | BEARISH |

Step 5. Given the health of the market indexes, it is then possible to understand the major market trends and select an investment strategy which is aided by the overall market direction.

The money to be invested is then split to allow 2 purchases of each individual stock. The first purchase occurs when the stock moves into the Basing phase. The second purchase occurs when the stock moves into the Advancing phase. Covered Call options should be written for the next higher striking price.

When the stocks move into the Hovering phase, the Covered Call option positions should be closed & the stocks sold. Once the stock's price has peaked, a short position can be created.

The short position is maintained while the stock is in the Declining phase. Once the stock reverses from it low point, the short position should be closed before the stock changes to its Basing phase.

The following pages are printouts from the Phase & Status Report web site which explains the process in greater detail & includes charts to demonstrate to process.

[image]

[image]

[image]

[image]

[image]

[image]

[image]

1. What I claim as my invention is a “Process to determine the Health of Stock Market Indexes & Individual Stocks”. The subject process is a multiple step analytical means of measuring the current health of the subject issues.
Use of this process allows computer programs to select issues to be considered for purchase or sale. The subject process, computer programs, and graphic images are my own creation.
The process is explained in the abstract of technical disclosure and in greater detail in the detailed description of this patent.
